(19) United States
(12) Patent Application Publication
(10) Pub. No.: US 2002/0129892 A1
(43) Pub. Date: Sep. 19, 2002

(54) System, method and device for the electronic provision of current dating labels for food and perishables

(76) Inventor: Thomas Brown, Massapequa, NY (US)

Correspondence Address: Mitchell A. Stein, Esq., STEIN & ASSOCIATES, P. C., 489 Fifth Avenue, 29th Floor, New York, NY, 10017, US

(21) Appl. No.: 09/809,976

(22) Filed: Mar. 16, 2001

(51) Int. Cl. B41J 1/00

(52) U.S. Cl. 156/277; 358/1.1

(57) ABSTRACT

A system, method and device for providing current date labels for food contained in a container while indicating the event occurring on the date and time indicated, including “purchased,” “opened,” “cooked,” and “frozen.” The device includes a data entry unit for entering commands concerning the event, a processing unit for receiving the entered commands, maintaining the then current date, and transmitting a print command, and a printing unit for receiving the print command from the processing unit and printing the event with the then current date and time on a label. The label indicates the event and the date of its occurrence, and is then affixed to a container for the food. The food container, thereby labeled, will provide an indication of the date of the event for future reference.

### FIELD OF THE INVENTION

The present invention relates to the field of identification of food and other perishables, and more particularly to accurate, current dating of containers for such products.

### BACKGROUND OF THE INVENTION

Invariably food is purchased, opened and cooked by virtually every person on the face of the planet. When purchased, the buyer will look for a label, typically provided by the manufacturer or distributor, indicating, in accordance with FDA requirements, an expiration date by which the food item must be sold. The later the date, in the buyer's view, the fresher the contents.

Yet, after acquisition, a food item in a container is then taken home by the buyer and if not consumed immediately, will find its way to a shelf, drawer, closet or refrigerator. Then, the only indication of the age of the contents is the expiration date, provided that the contents have not been stored in a household storage device (like a bowl with a cover), for which no indication is provided. Where food items are stored in a manner other than by way of their original container, or are cooked or otherwise created other than commercially, or are opened and not fully consumed, these items traditionally are stored, typically in a refrigerator, with the expectation of later consumption, but without any indication of when the storage has occurred.

In some households, then, the refrigerator becomes a repository of “left overs” that may later be consumed or, in the worst instance, may become the equivalent of a science experiment, remaining in the refrigerator until their experimental nature is fully revealed by mold, odor or other foul consequences. Bacteria-laden food products in a refrigerator also pose a hazard where it is not evident from viewing the food product that its contents host such bacterial invasion.

Accordingly, it is an object of the subject invention to provide a system and method that indicates an accurate, current date of a food item or other perishable, logged with its status as “purchased,” “opened,” “cooked,” “frozen” or other similar description.

It is another object of the subject invention to provide a home owner with a convenient mechanism to date stamp food containers with a current date after purchase, opening, cooking or freezing.

It is still another object of the subject invention to provide a reliable technique for indicating the date of storage of food items.

### SUMMARY OF THE INVENTION

The various features of novelty which characterize the invention are pointed out with particularity in the claims annexed to and forming a part of the disclosure. For a better understanding of the invention, its operating advantages, and specific objects attained by its use, reference should be had to the drawings and descriptive matter in which there are illustrated and described preferred embodiments of the invention.

The foregoing objects and other objects of the invention are achieved through a system, method and device for providing current date labels for food contained in a container while indicating the event occurring on the date indicated, including “purchased,” “opened,” “cooked,” and “frozen.” Moreover, the invention provides the ability to place such current date labels in any convenient location on the food storage container, for ease of viewing.

Thus, when an item is purchased from the store and is contained in a container, while the expiration date mandated by law is provided on the item, the item, in accordance with the current invention, can also be stamped with the date of its purchase. In other words, as the grocery bag is being unloaded and the groceries placed on shelves or in a refrigerator, the invention provides a label identifying the item as “purchased” with a date of that event.

Likewise, when an item is removed from a shelf or refrigerator and is opened, where the contents are not fully used, the item is labeled in accordance with the invention with a label that identifies the item as “opened” with a date of that event. In this manner, items that are ordinarily not fully consumed, like catsup, tomato sauce, syrup and the like, will have a visual indicator of the date of purchase and a visual indicator of the date of opening. In this manner, the consumer can be aware of the duration between these events and minimize the potential of spoiling bacterially or otherwise, or other consequences of prolonged delay between events, for greater health and safety.

Similarly, when a meal is cooked and there are left-overs, and the left-overs are frozen, the invention provides a label that may be affixed to the freezer-wrap indicating the date of freezing. Otherwise, the left-overs can be marked with an “opened” event and a date of that event.

The device includes a data entry unit for entering commands concerning the event, a processing unit for receiving the entered commands, maintaining the then current date, and transmitting a print command, and a printing unit for receiving the print command from the processing unit and printing the event with the then current date on a label. The label indicates the event and the date of its occurrence, and is then affixed to a container for the food. The food container, thereby labeled, will provide an indication of the date of the event for future reference.

The device maintains a date in real time, and it is this date that is printed on the label. In this manner, a failsafe dating system is created that does not require that the user change the date once it is set upon original device initialization.

Thus, the device is located preferably on the kitchen counter, which is proximate to storage, cooking and freezing areas, so that its utility can be fully realized. When food is purchased, a label indicating the date of that event is affixed to the container. When cooked and thereafter stored, a label indicating the date of that event is affixed to the container or wrapping. When opened, a label indicating the date of that event is created and affixed. Likewise, when frozen, a label indicating the date of that event is created and affixed to the freezer-wrap.

The device is either hand-held or desk top, and operated either by battery or wall power.

It is thus a feature of the instant invention to provide date labels for events critical to the status of food that is stored, namely dates of purchase, opening, cooking, and freezing.

It is a further feature of the instant invention to provide a user-friendly, hand-held device for affixing labels to food containers that indicate the dates of critical events relative to the contents and thereby minimize the potential of bacterial or other disease related states and spoiling of the food.

It is yet a still further feature of the instant invention to provide a date stamp that can be conveniently located for ease of reference by the consumer.

### BRIEF DESCRIPTION OF THE DRAWINGS

In the drawings, wherein similar reference characters denote similar elements through the several views:

FIG. 1 is a diagrammatical view of the major method steps of a preferred embodiment of the subject invention;

FIG. 2 is a schematical representation of the components of a preferred embodiment of the subject invention;

FIG. 3 is a frontal, representative view of the device in accordance with a preferred embodiment; and

FIG. 4 is a representative view of certain items labeled in accordance with a preferred embodiment of the subject system and method.

### DETAILED DESCRIPTION OF THE PREFERRED EMBODIMENTS

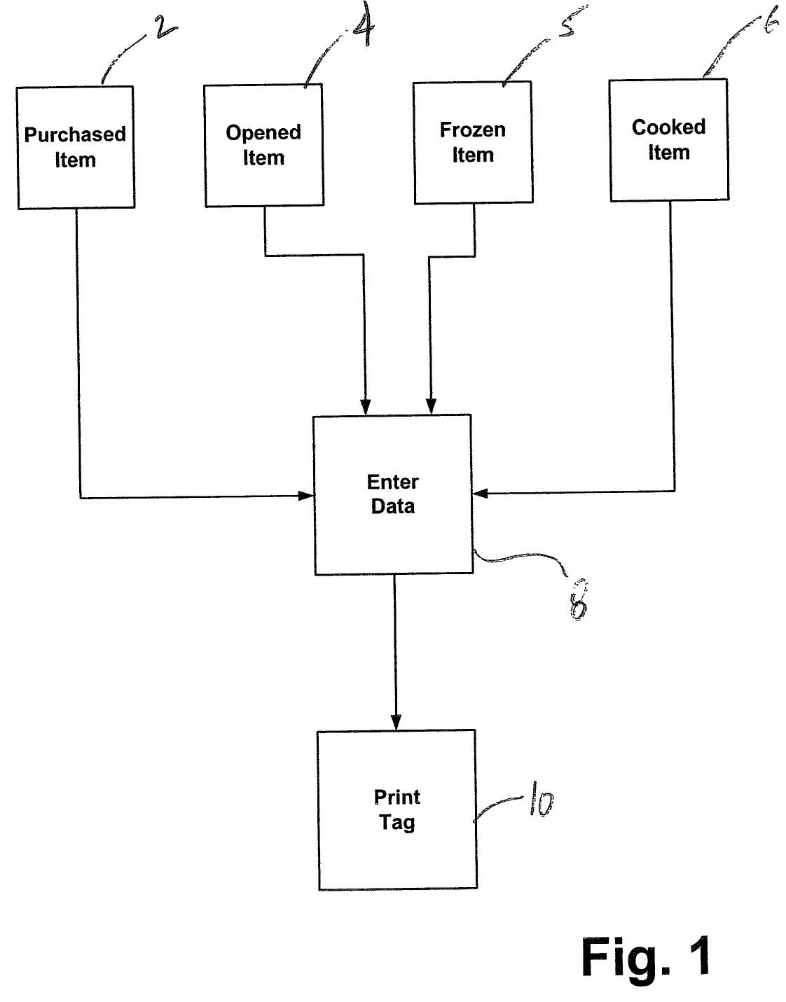

In accordance with the subject invention, and with particular reference to FIG. 1, data is entered at enter data step 8, and, in the preferred embodiment, is selected from four items, either purchased item 2, opened item 4, frozen item 5, or cooked item 6. After the data entry step 8 is completed by selection from the item choices 2, 4, 5 and 6, a tag is printed at step 10, and the tag is affixed to a container holding the food material or other perishable. Purchased item 2 thus provides a tag indicating a date of purchase, which is affixed to the item purchased. Likewise, opened item 4 provides a date of opening, frozen item 5 provides a date of freezing, cooked item 6 provides a date that the food was cooked.

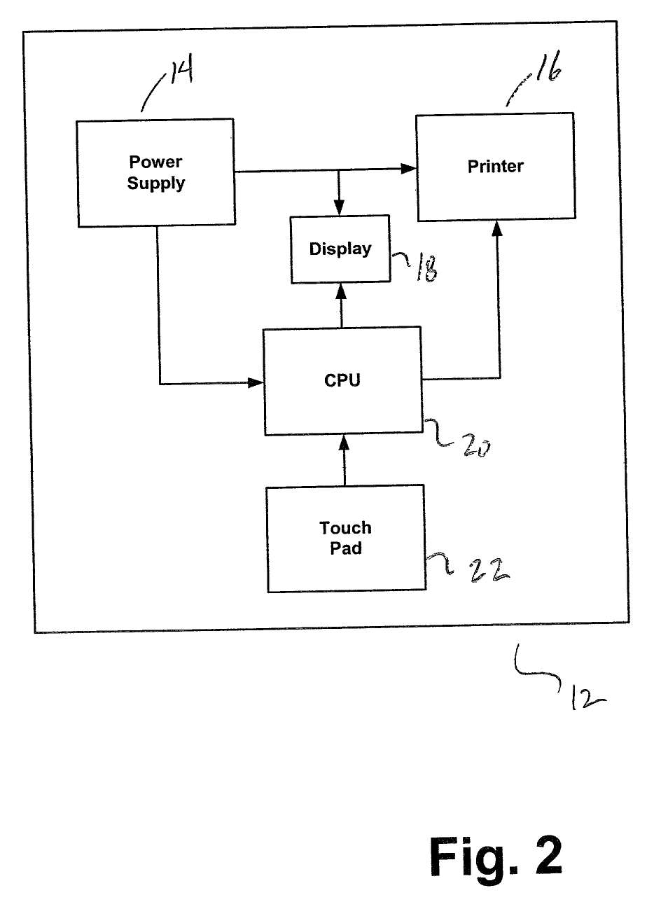

With reference to FIG. 2, the device 12 itself is shown, having functional components of a power supply 14 which feeds power to a central processing unit 20, a display 18 and printer 16. Touch pad 22 is employed to enter data to unit 20. Unit 20 displays the selection (and date and time) via display 18. Printer 16 is a printer in the nature of thermal or ink jet, or other like kind printer known by one of ordinary skill in the art that does not exceed the power provision of power supply 14. Fed to the printer 16 is preferably a label tape with pealably attached labels that, after printing, may be removed from their backing and contain an adhesive surface for attachment to a container holding food or other perishables.

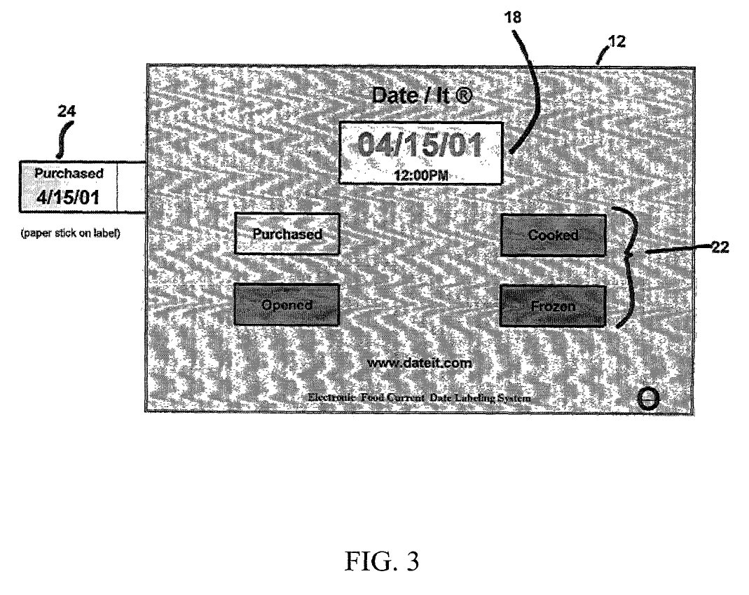

As shown in FIG. 3, device 12 reveals display 18 and touch pad 22, comprised, in this embodiment, of four buttons labeled “purchased,” “opened,” “cooked,” and “frozen.” These four buttons demonstrate true simplicity of operation. Also shown is a sample printed label 24 which indicates, in this example the phrase “purchased” with a date stamp below, indicating the date of that event. It should be appreciated that device 12, as shown in FIG. 3 allows the user to press one of the four item buttons (i.e., “purchased,” “opened,” “cooked,” and “frozen,”) and when the item is pressed, the sticker is printed with that item and the current date in “real time.” It should be appreciated that once the device's clock is set for “real time” the user no longer has the easy ability nor the need to change the setting, and by simply pressing one of the four buttons will receive a tag with the relevant item selected and current date imprinted thereon.

Accordingly, when one purchases groceries, by way of example, and is unloading the bag, device 12 is employed to tag each item with a “purchased” date label. When the item is opened and not fully consumed, the item can then be date stamped “opened.” The same technique is employed for “cooked” and “frozen.”

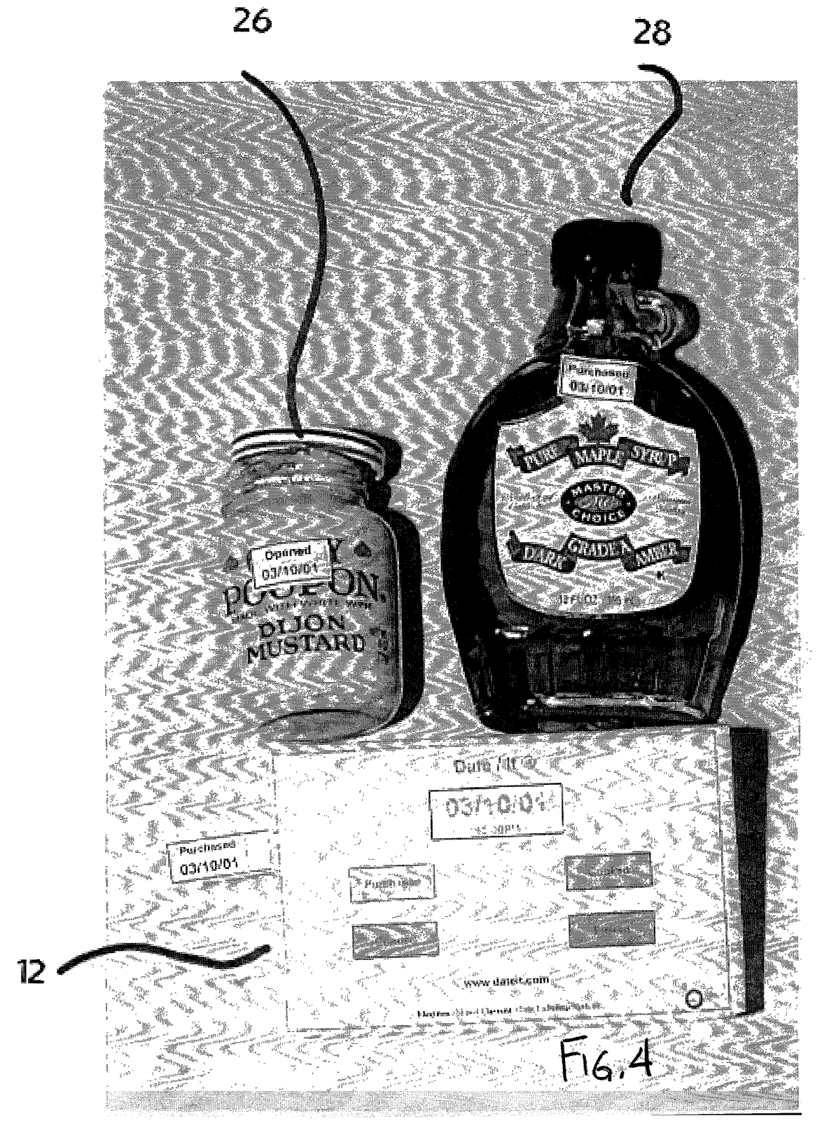

As shown in FIG. 4, items like mustard are labeled with an “opened” and a date 26, and syrup with a “purchased” and a date 28. Device 12 thus provides a source of reliable information concerning the age of food material heretofore unavailable to the consumer.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

I claim:

1. A method for providing an accurate indication of the date and status of materials contained in a container, comprising:
(a) determining the status of the materials;
(b) entering in a data acquisition device the status of the materials;
(c) printing a tag that indicates the current date in real time and the status entered; and
(d) placing the printed tag upon the container.

2. The method of claim 1, wherein the entering step further comprises:
(a) viewing a list of status items;
(b) selecting from said list the status that most closely aligns with the status determined; and
(c) keying a data entry mechanism in accordance with said selection.

3. The method of claim 1, wherein said materials are perishables.

4. The method of claim 1, wherein said materials are food.

5. The method of claim 2, wherein said status item is selected from the group consisting of “purchased,” “opened,” “cooked,” and “frozen.”

6. A device for indicating the date and status of material in a container, comprising:
(a) a data entry unit for entering commands concerning the status of the material;
(b) a processing unit for receiving the entered commands, maintaining the then current date in real time, and transmitting a print command; and
(c) a printing unit for receiving the print command from the processing unit and printing the status and then current date on a label.

7. The device in accordance with claim 6, wherein said device is hand-held.

8. The device in accordance with claim 6, wherein said device fits on a desk top.

9. The device in accordance with claim 6, wherein said device is battery powered.

10. The device in accordance with claim 6, wherein said device is powered from a wall outlet.

11. The device in accordance with claim 6, wherein the commands concerning the status of the material are selected from the group consisting of “purchased,” “opened,” “cooked,” and “frozen.”

12. A system for accurately indicating the date of an event in real time concerning a food material, comprising:
(a) an originating step selected from the group consisting of purchasing the food material in a container, storing the food material in a container, storing a container containing the food material, opening the food material from a container, cooking the food material, and freezing the food material; and
(a) a date stamping step for affixing the actual date of the originating step in real time with a visual indicator that uniquely identifies the originating step.

13. The system of claim 12, wherein each originating step has a special, unique button for pressing which, when pressed, engages the date stamping step.

14. The system of claim 12, wherein the date stamping step is performed by a hand-held device.

15. The system of claim 12, wherein the date stamping step is performed by a device powered by a wall outlet.

16. The system of claim 12, wherein the food material is contained in a container and the actual date and visual indicator are affixed to a label which is placed upon the container.

17. The system of claim 12, wherein the visual indicators are selected from the group consisting of “purchased,” “opened,” “cooked,” and “frozen.”
